(19) United States
(12) Patent Application Publication
(10) Pub. No.: US 2009/0165038 A1
(43) Pub. Date: Jun. 25, 2009

(54) Network media insertion system

(76) Inventors: Bob Hall, Murray, UT (US); Martin Charles Alcock, Calgary (CA)

Correspondence Address: Joseph Curtis Edmondson, 15490 NW Oak Hills Dr, Beaverton, OR, 97006, US

(21) Appl. No.: 12/287,793

(22) Filed: Oct. 14, 2008

Related U.S. Application Data
(60) Provisional application No. 60/979,656, filed on Oct. 12, 2007.

(51) Int. Cl. H04N 7/025

(52) U.S. Cl. 725/32

(57) ABSTRACT

An advertisement insertion system and methods are described which allows for the insertion cues to be gathered at a number of program feeds, these insertion cues are then consolidated on a single network control station, and then the cues are distributed to client control stations that control the inserting of media on cable television networks.

### RELATED APPLICATIONS

This application claims the benefit of and priority to U.S. Provisional Application Ser. No. 60/979,656 filed Oct. 12, 2007 by Bob Hall and Martin Alcock, the contents of which are hereby incorporated by reference as if recited full herein for all purposes.

### BACKGROUND

The inventive subject matter relates to the field of insertion of multimedia material (e.g. video, audio, text, etc.) in a distributed cable networks in general and insertion of advertisements in particular. While the principles of the inventive subject matter may apply to any form of broadcast media, television media (e.g., video and audio transmitted on the television frequencies) will be emphasized herein as a representative example.

A common broadcast system is a distributed video cable network and the following disclosure will use this system as an example. Broadcast television networks allocate a number of advertisement slots every hour (e.g., “local availability”) to local distributors of their content. Insertion of video advertisements for local availability consists of inserting broadcast advertisements with local, more specific advertisements.

The value to the distributor is that the advertisements are locally tailored to the target audience on a geographic and/or demographic basis. With the advent of digital technologies and set top boxes, local broadcast advertisements can be selectively displayed on a single set top box. The set top box connects to the television which is typically viewed by a specific user.

A television signal, typically relayed by a satellite system is captured by an local antenna which provides the broadcast feed. The broadcast feed may contain a few channels or hundreds of channels. At various intervals the satellite systems broadcast audio signals (known as “cue tones”). An advertisement insertion signal signals the local distributor of the broadcast feed that it can be switched from the syndicated broadcast to the local broadcast, either for the insertion of short advertisements or longer infomercials.

A television signal may also be transmitted digitally. This digital transmission is typically done in a compressed MPEG video stream. A cue-tone signal is derived from the MPEG video stream either in the form of a signal, typically in a standard format known as ANSI/SCTE 35 (American National Standards Institute/Society for Cable Television Engineers).

The technology supporting the insertion of video advertisements in a video stream have improved during the last two decades. Analog video insertion systems utilized a system to detect cue-tones, start a video tape having the local advertisement, switching the broadcast feed, waiting the local advertisement to end. and then switching the broadcast feed. The insertion of video advertisements from digital video requires detecting the advertising signal (e.g., cue-tone) in the digital stream, followed by digitally splicing and inserting the local advertisement, into the digital stream. (See generally “Digital Splicing”, Peter Chave. Broadcast Engineering, May 2007. Penton Business Media) which is incorporated herein by reference.

The prior art relies on advertisement insertion signals or signals that are inserted by the broadcasters to synchronize the insertion of advertisements. If the cue-tone is lost or not detected then potentially the national advertisement will be transmitted in lieu of the local advertisement leading to a loss of revenue for the broadcaster. Cue-tone signals may be lost if the audio synchronization channel becomes corrupted or alternately the cue-tone is not encoded into the compressed digital file. The result of a lost cue-tone is that the television viewer may see a blank spot during the transmission and lost revenue to the distributor.

The prior does not disclose cue-tones generated independently from the broadcast signal. There is a particular need for “custom cue-tones” where a cue-tone is internally generated by the local distributor to allow the insertion in places beyond those associated with an original broadcast of media. For example, local stations might find it desirable and advantageous to increase the number of places where ads could be inserted. For instance, segments in a media broadcast corresponding to infomercials could be marked with cue tones so that local stations could replace such segments with weather alerts, crime notices, or more relevant infomercials or advertisements.

### SUMMARY

The inventive subject matter overcomes problems in the prior art by providing a networked media insertion system with the following qualities, alone or in combination.

The media insertion system is configured as a distributed system interconnected by the data network. A broadcast feed contains a media insertion signal, usually a “cue tone” for analog video feeds or a data signal for compressed video files. The media insertion signal is further distributed by a network control station to other control stations. There is also a method of receiving and propagating media insertion signals, which involves receiving the media insertion signals from a broadcast feed or internally from the network, storing the signal in a central controller, then propagating those signals to control systems.

These and other embodiments are described in more detail in the following detailed descriptions and the figures.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

FIG. 1 is a system diagram of the prior art depicting a broadcast transmitter, a satellite relay, a receiver from the satellite relay, a distribution station, a broadcast feed switch.

FIG. 2 is a timing diagram of the prior art depicting the output from the broadcast feed, the supervisory audio channel, the advertising feed, and the local distribution feed.

FIG. 3 is a network diagram of the preferred embodiment showing the connection of the local distribution systems to the data network and the network controller.

FIG. 4 is a timing diagram of the preferred embodiment showing the detection and transfer of the information pertaining to the supervisory audio channel.

FIG. 5 is a flowchart of the software operation of the preferred embodiment.

FIG. 6 is a flow diagram of the media insertion signal in the network.

### DETAILED DESCRIPTION

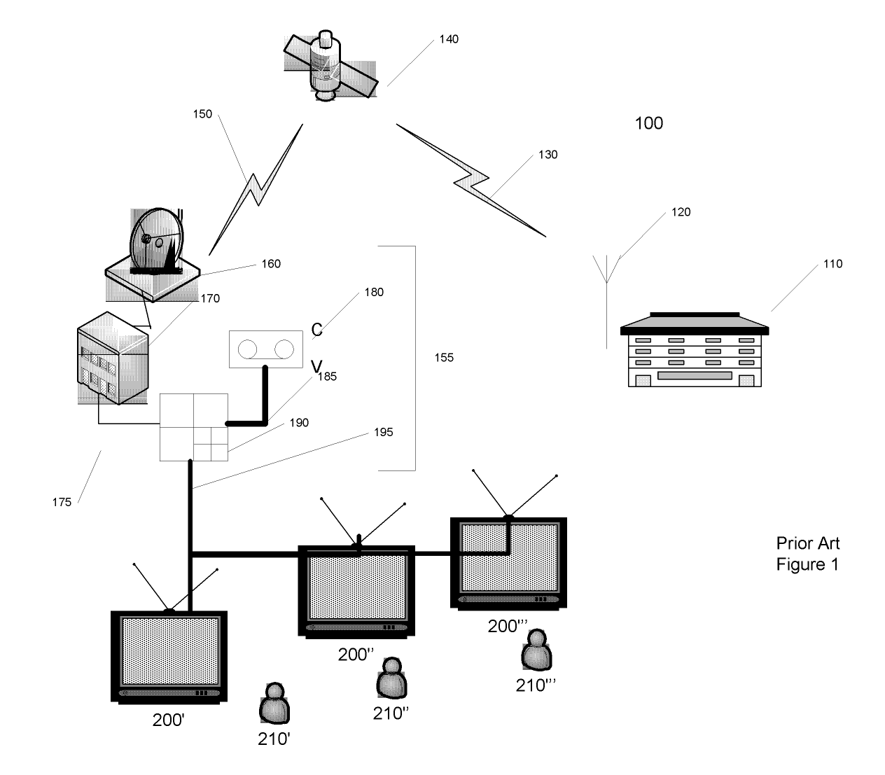

Representative embodiments according to the inventive subject matter are shown in FIGS. 1-6, wherein similar features share common reference numerals.

The following terms and definitions are used in the understanding of the prior art and the inventive subject matter. These definitions should be interpreted as broadly as possible in view of the inventive subject matter.

The following examples will illustrate media broadcasting in the form of a television broadcast, however this merely for illustration and the subject matter is understood not to be limited to television broadcasts.

Advertising Feed is generally defined as a short length of media broadcasts on a communications network, but, for the purposes of this application may include either video or audio broadcasted in any format

Media Insertion Signal! Advertisement Insertion Signal or a Cue Tone is defined as an external signal to indicate when the advertising feed is inserted in lieu of the broadcast feed. The media insertion signal typically is a DTMF tone on a audio supervisory channel or a signal from encoded within a MPEG file for digitally compressed video files.

Broadcast Feed or Program Feed is defined as a composite video and audio signal broadcasted by the television networks. This signal also contains channels not available to the viewers that are used for distribution purposes, such as the generation of cue-tones.

Clock is defined as a network enabled timekeeping device, which may include, but is not limited to, a GPS clock or in areas without satellite access an atomic clock.

Data Network is generally defined as the Internet, but may include other proprietary and non-proprietary data communication networks that allow for multiple computers to be interconnected, including, but not limited to local area networks, wide area networks, Value Added Networks (V AN), and Electronic Data Interchanges.

Local Availability is generally defined as the time slots made available by the national networks for advertisement on particular broadcast channels that are available to the local distributors.

Local Distribution Systems generally refers to a local television network that receives the Broadcast feed and redistributes the audio and video content to a local group of viewers.

This application also incorporates by reference “AD Systems, Addige.NET Remote Insertion System Technical Specification, Revision 1.03, Dated Feb. 28, 2007 by Martin Alcock (AD Systems, West Murray Utah 84107”.

Now referring to the prior art FIG. 1 which shows the architecture of the video distribution system. The video signal on the video distribution system 100 originates at the national network 110. The national network 110 broadcasts on a number of video channels (e.g. CH #1, CH#2, CH#3, etc shown as USA, ESPN, TBS, TNT.) with programming content on each channel. These channels are multiplexed onto a satellite uplink 130 generated by the transmitter 120. The satellite rebroadcasts the channels on a satellite downlink 150 to the distribution network 155.

The distributionsy″stem. 155 receives the satellite broadcast on the downlink 150 via the receiver antenna 160 which is connected to the local distribution system 170. The local distribution system 170 incorporates a switch 190 and an advertising feed system 180. The output from advertising system 180 is the advertising feed 185. The input to the switch 190 is the broadcast feed 175 and the advertising feed 185. The output from the switch is the distribution feed 195. The distribution feed 195 is transmitted to televisions 200′,200″,200″′ viewed by users 210′, 210″, 210″′,

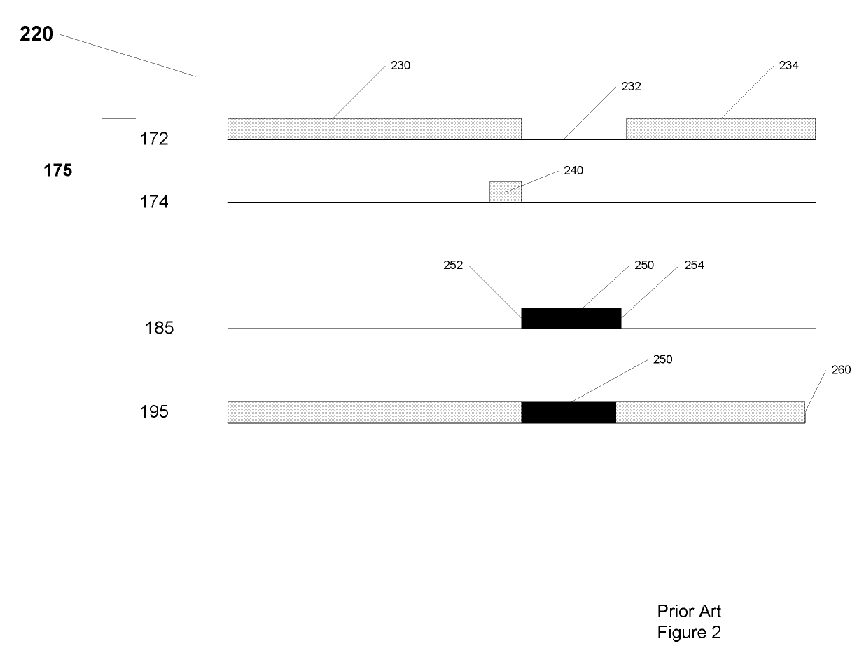

Now referring to prior art FIG. 2 that depicts a detailed view of the operation of the switch 190. The input to the switch 190 is the broadcast feed 175 and the advertising feed 185. The output from the switch 190 is fed to the televisions 200 and the viewers.

A timing diagram 220 of the signals relevant to the switch 190. The broadcast feed 175 consists of two channels, the broadcast video channel 172 and the supervisory audio channel 174. During normal operation the signal from the broadcast video channel 175 is routed to the distribution feed 195. When the period starts for local programming a cue-tone or advertisement insertion signal 240 is transmitted on the supervisory audio channel 174. This cue-tone 240 is detected by the switch and the switch 190 switches from the distribution feed 175 to the advertising feed 185 for the period of the advertisement 250. The composite signal 260 of the distribution feed 195 appears on the televisions 200 and to the viewers 210 as one contiguous video stream.

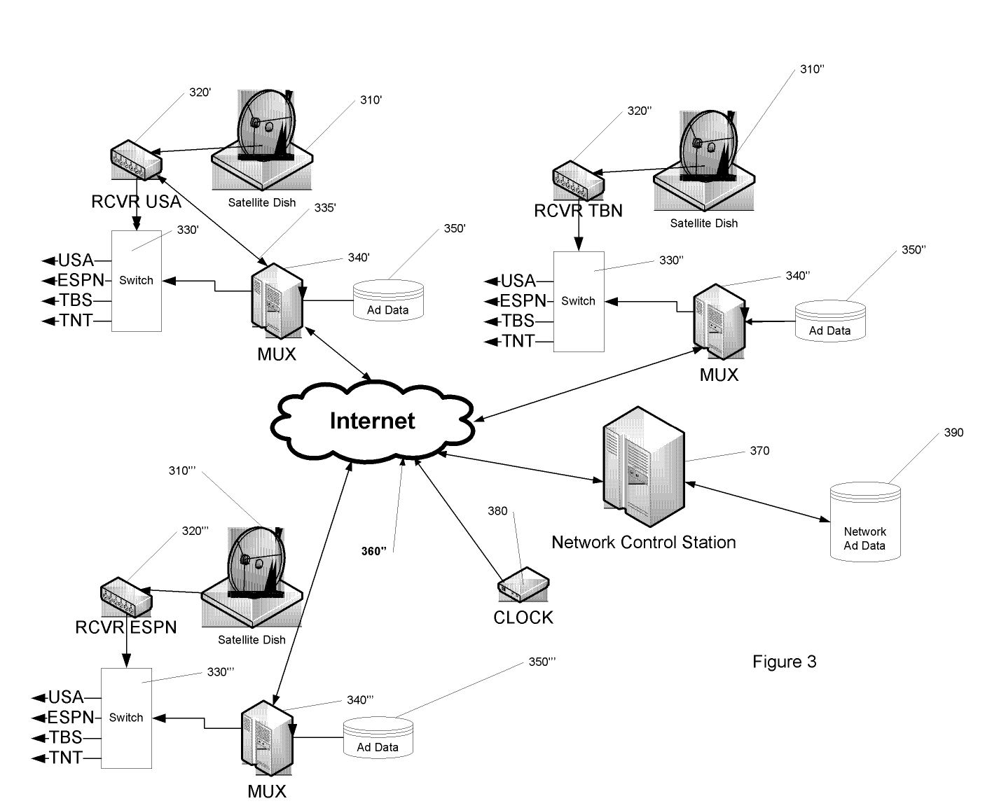

Now referring to FIG. 3 that depicts a system diagram of the preferred embodiment of the networked media insertion system. A network of local distribution systems (310, 320,330,340,350) are interconnected to the data network 360. A network control station 370 provides configuration and control of local distribution systems. An external clock 380 provides accurate timing to the network.

The broadcast video stream is captured by a satellite dish, 310 at a local distribution center with a receiver 320. As depicted here the local distribution system receives a single video channel (e.g., 310′, 320′ receives the USA network) and transmits multiple channels to the local distribution system (e.g. 330′ transmits USA, ESPN, TBS and TNT). The video portion of the receiver is fed into a video switch 330 and is controlled by the client station 340. The supervisory audio channel 335 which embodies the “cue-tone” or ad insertion signal is split off from the broadcast signal and routed to the client station 340. In the alternate embodiment where a compressed digital file is present at 320, such as in the MPEG format, the receiver 320 has additional circuitry to extract the signal. The media feed 350 is connected to the client station 340. The client station 340 is also connected to the data network 360 allowing for each of the local distribution systems (310-350) to interact with each other.

During operation the network control station 370 will continuously poll the client stations 340 to determine the status of the supervisory audio channels 335. If one of the supervisory audio channels 335 is disabled, a substitute signal is subsequently transmitted over the data network 360. The network control station 370 serves as a central location where all of the cue-tones from each of the supervisory audio channels 335 are stored for dissemination to each of the local distribution systems.

The network control station 370 serves as the central interface for distributing media insertion signals to the client stations 340. The network control station 370 consists of a database (not shown) that contains a list of “cues” which represent when and at what location media insertions will occur. The cues are gathered from the client stations 340.

Other embodiments include an interrupt driven architecture, where the status of the supervisory audio channel 335 is locally polled by the switch 340. If the switch 340 detects that the channel is disabled, a signal is sent to the network control station 370.

An alternate embodiment includes the elimination of the supervisory audio channel 335 or the detection hardware needed to extract the signal from the MPEG file, on all but a subset of the local distribution systems (310-350). Those systems with supervisory audio channels 335 would broadcast the supervisory audio channel information from the network controller 370 via the data network 360 to those local distribution systems (310-350) which lack a connection to the supervisory audio channel 335.

An alternate embodiment would incorporate a highly accurate reference clock 380 (e.g. a GPS clock made by Symmetric on or equivalent or an atomic clock) to insure that the advertising feed is synchronized to start within one video frame of the termination of the broadcast feed.

An alternate embodiment allows the network controller 370 to not only provide the supervisory audio channel or media insertion signal, but, to also provide network ad data 390. The network ad data 390 is routed from the network controller 370 via the data network 360 to the client station 340 and output as an media feed on the video switch 330.

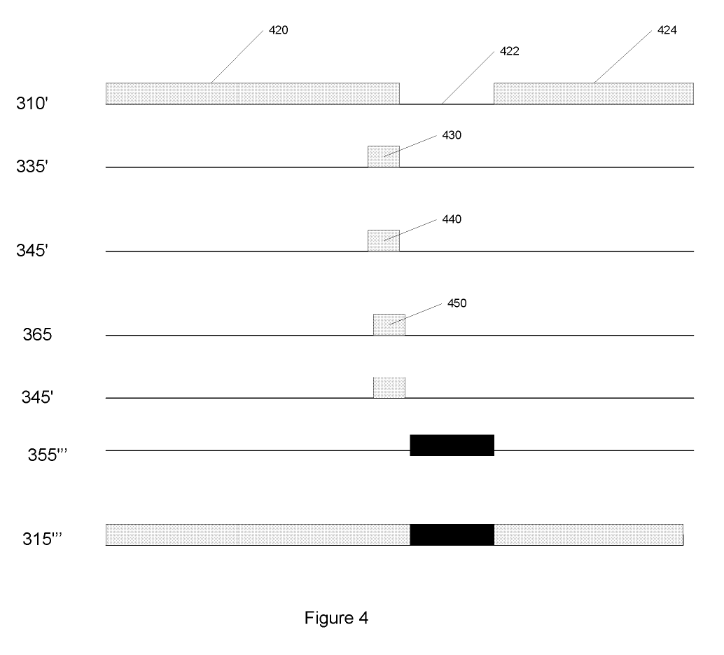

Now referring to FIGS. 3 and 4 which is a timing diagram of the supervisory audio channel information of the preferred embodiment as it transferred from the receiver to the network controller to the a remote local distribution system. The broadcast signal is received by the antenna 310′ (FIG. 3) with the signal depicted by the timing diagram.

The broadcast feed at 310′ is 420′. The broadcast feed operates during a period of transmission 420′ and 424′. There is a period of no transmission 422′ where the advertising feed is broadcast. The supervisory audio channel 33S′ is represented by a signal 430. The advertisement insertion signal is detected on the supervisory audio channel 1335′ signal is detected by the switch 340′. The supervisory audio channel signal 440 is transmitted 445 from the switch to the data network 360 and then from the data network to the network control station 365. The signal from the switch to the network control station 370.

In the alternate embodiment where a compressed digital file, such as an MPEG-2 file is used, the advertisement insertion signal (e.g. the signal equivalent to the supervisory audio channel 335′) is extracted from the MPEG-2 file and used in the same manner as indicated above.

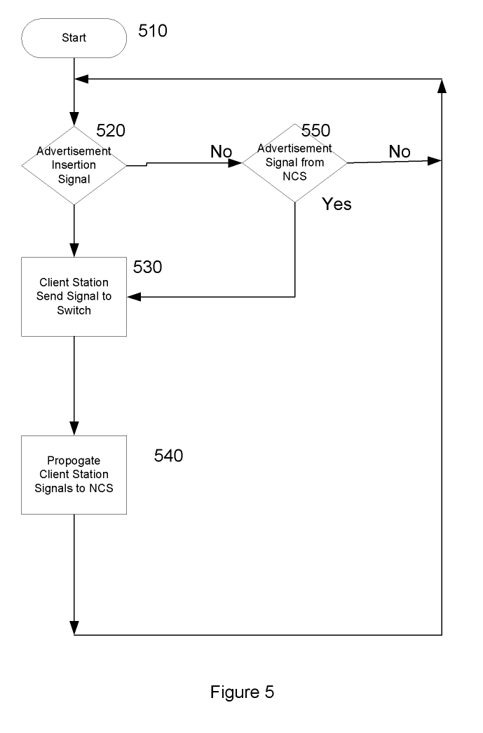

Now referring to FIG. 5 which depicts a flowchart of the propagation of the supervisory audio channel from one receiver channel to another. The software starts 510 and queries 520 the supervisory audio channel. If there is an media insertion signal (e.g. a DTMF tone on the supervisory channel or a signal from an MPEG-2 video file) the client station issues a command 530 to the switch. The switch then selects (not shown) the proper media segment and determines the length the segment will run. The command is propagated 540 to the Network Control Station (NCS), where the cycle repeats. If there is no media signal from the broadcaster 530, either due to corruption of the supervisory audio channel or lost information in the MPEG-2 file, then a table is checked 550. The table contains entries from the Network Control Station (NCS) that may have been broadcast from other client stations via the network control station.

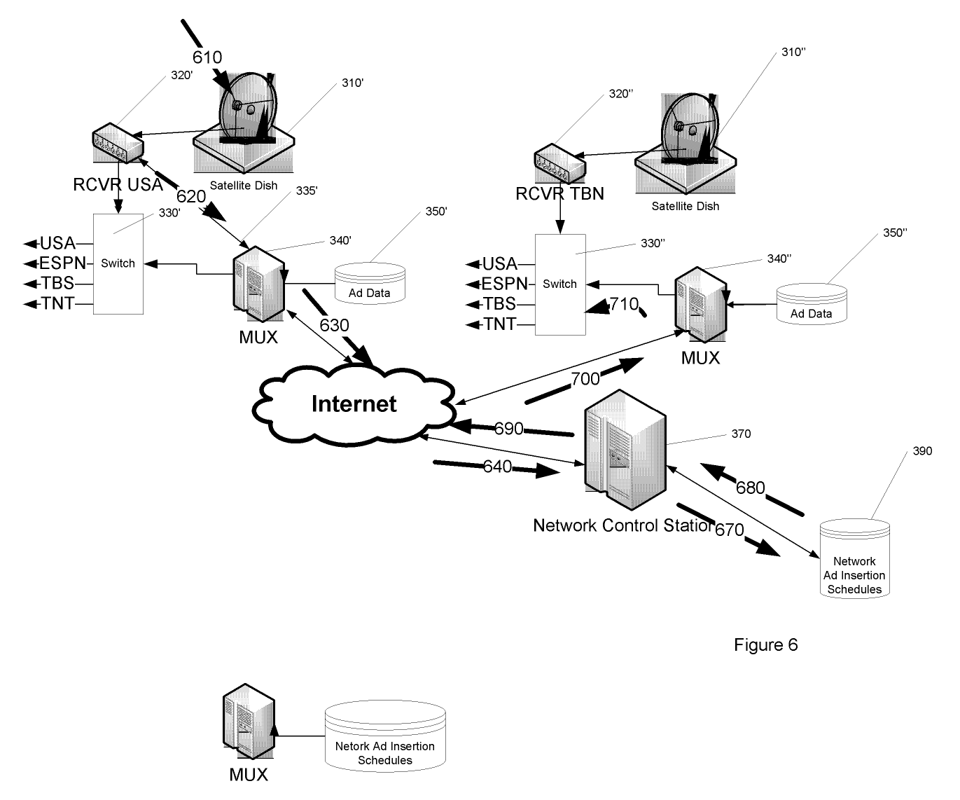

Now referring to FIG. 6, which is a flow diagram of the propagation of the media insertion information from the broadcast feed to the network control station to a control station. The media insertion information is incorporated into the broadcast feed 610. The media insertion information is removed from the broadcast feed 610 either from a supervisory audio channel 620 or extracted from an MPEG-2 file. The media insertion information is then propagated from the control station to the data network and onwards to the network control station 630,640. The media insertion information is then stored in the database of the network control station 670. This database information is then extracted 680 and propagated 690,700 to all insertion sites with control stations 700. At the proper time of advertisement insertion the control station operates 710 the switch, which inserts the advertisement.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

1. A media insertion system, comprising one or more control stations(s), wherein each control station includes a broadcast feed input, an advertising feed input, a local output, and a switching apparatus, wherein the switching apparatus connects the broadcast feed input or the advertising feed input to the local output based on a media insertion signal, wherein the media insertion signal is not simultaneously transmitted with the broadcast feed input.

2. The media insertion system of claim 1, wherein the media insertion signal is determined by an audio synchronization channel

3. The media insertion system of claim 1, wherein the media insertion signal is determined by a signal in a compressed video digital file.

4. The media insertion system of claim 1 wherein the media insertion signal is determined by a network controller.

5. The media insertion system of claim 4 wherein the network controller further comprises scheduling software for the generation of media insertion signals.

6. The media insertion system of claim 4 wherein the network controller receives media insertion signals via data network messaging protocols.

7. The media insertion system of claim 1 wherein the media insertion signal is determine by a control station.

8. The media insertion system, as in claim 1 wherein the accurate clock is selected from a group consisting of OPS Clocks and/or Atomic Clocks.

9. The media insertion system of claim 1 wherein the control station is connected to the data network and the media insertion signal originates from the data network.

10. A method for inserting media, the method comprising reading a media insertion signal from a first broadcast feed connected to a control station, transmitting the status of the media insertion signal to a central network control station, propagating the status of the media insertion signal to all control stations that require the media insertion signal.

11. The method of inserting media of claim 10, wherein the propagation of the media insertion signal is synchronized within one frame.

12. The method of inserting media as in claim 10, wherein the timing of the synchronization is done by an accurate clock.

13. A method for inserting media as in claim 10 wherein the synchronization of media insertion signals further comprises a means for gathering media insertion signals from a distributed network, determining the date, time of when the mediation insertion signals will be activated, comparing the date and time of activation of the media insertion signals, with an accurate clock, such that the media insertion signals are executed at the designated time.

14. A system for synchronization media insertion signal comprising a network control station configured to capture media insertion signals from a broadcast feed, and to propagate media insertion signals to a plurality of local control stations so that the local controls are enabled for local media insertion for the broadcast feed.

15. A system for synchronization media insertion signal as in claim 14 wherein the media insertion signal is a custom signal that does not correspond to a media insertion signal generated by or included with an original broadcast feed.
